(19) United States
(12) Patent Application Publication
(10) Pub. No.: US 2013/0049348 A1
(43) Pub. Date: Feb. 28, 2013

(54) DEVICE, SYSTEM, AND METHOD FOR ORGANIZING AND RETRIEVING CARDS

(71) Applicants: Amber LEMNA, Jordan, MN (US); Elizabeth A. HATTARA, Medina, MN (US)

(72) Inventors: Amber LEMNA, Jordan, MN (US); Elizabeth A. HATTARA, Medina, MN (US)

(21) Appl. No.: 13/601,091

(22) Filed: Aug. 31, 2012

Related U.S. Application Data
(60) Provisional application No. 61/529,320, filed on Aug. 31, 2011.

(51) Int. Cl. B42F 21/00; G06K 19/06

(52) U.S. Cl. 283/67; 235/494; 283/37

(57) ABSTRACT

An organization aid device, an organization aid carrier device, system, and method for organizing and retrieving cards is disclosed. The organization aid device allows for organization of plurality of card-like devices and quick identification of a particular card-like device from a stack of similar card-like devices, such that when a plurality of card-like devices are stored in a confined carrier, a desired card-like device can be accurately retrieved from the rest of the card-like devices and/or from the confined carrier.

### FIELD

This description relates to an organization device, system, and method for organizing and/or managing one or more cards.

### BACKGROUND

Various organization devices for managing cards, such as credit cards, have been developed. For example, wallets have one or more holders for placement of credit card for organization purposes. There is a need for improvements in organization devices, systems, and method for managing one or more cards.

### BRIEF SUMMARY

An organization aid device which permits efficient identification, management, and/or access to credit card, debit cards, and other card-like devices from each other and/or within a carrier for carrying card-like devices is described.

An organization aid carrier device for convenient packaging of the organization aid devices is described.

An organization system which wherein a plurality of organization aid devices are used for efficient identification, management, and/or access to credit card, debit cards, and other card-like devices from, for example each other and/or with a carrier for carrying the card-like devices, is described.

An organization method for efficient identification, management, and/or access to credit card, debit cards, and other card-like devices from each other and/or within a carrier for carrying card-like devices is described.

A method of manufacturing the organization aid device and/or organization aid carrier device is described.

### BRIEF DESCRIPTION OF THE DRAWINGS

FIG. 1a shows a front-side view of an embodiment of the organization aid device and an embodiment of the organization aid carrier device.

FIG. 1b shows a back-side view of an embodiment of the organization aid device and an embodiment of the organization aid carrier device.

FIG. 2 shows a close up portional view of an embodiment of the organization aid carrier device, wherein an embodiment of the organization aid device is being separated from the organization aid carrier device.

FIG. 3 shows a close up portional view of an embodiment of the organization aid device, wherein a removable layer is being removed exposing an adhesive layer.

FIG. 4 shows an example of a card having two organization aid devices attached thereto.

### DETAILED DESCRIPTION

An embodiment of the organization aid device 100 has a flat front side, a flat back side, wherein at least a portion of the back side surface includes an adhesive layer 200. As shown in FIG. 3, a removable layer 201 may be placed on top of the adhesive layer 200 to protect the adhesive layer 200 from unwanted attachment of the organizational aid device. The removable layer 201 is readily removable such that the removable layer 201 is removed prior to attaching the organization aid device 100 to a card-like device.

A card-like device includes, but not limited to, a credit card 300, an identification card, a business card, a security card, a RFID card, a passport, and other card-shaped devices.

The card-like device has a length and a width. As used herein, the length of the card-like device is longer than the width of the card-like device. Accordingly, as used herein, the credit card 300 has a length and a width, wherein the length is longer than the width.

As used herein, the card-like device includes, but is not limited to, a device that follow the international standards that defines the physical characteristics for card-like devices, such as for example, ISO/IEC 7810, ISO/IEC 7813, ISO/IEC 7811, and/or ISO/IEC 7816. Accordingly, the card-like device may have dimensions according to ID-1, ID-2, ID-3, or ID-000. A card-like device according to ID-1 has dimensions of 85.60 mm×53.98 mm. A card-like device according to ID-2 has dimensions of 105 mm×74 mm. A card-like device according to ID-3 has dimensions of 125 mm×88 mm. A card-like device according to ID-000 has dimensions of 25 mm×15 mm.

As used herein, the credit card 300 includes any card-like device used in financial transactions, such as for example, but not limited to, bank issued credit cards, merchant issued credit cards, charge cards, debit cards, government-issued payment cards, pre-payment cards, cash cards, and/or gift cards. The credit card 300 may follow ISO/IEC 7813 which defines additional characteristics of ID-1 banking cards, for example having dimensions of 85.60 mm×53.98 mm, a thickness of 0.76 mm, and corners rounded with a radius of 3.18 mm.

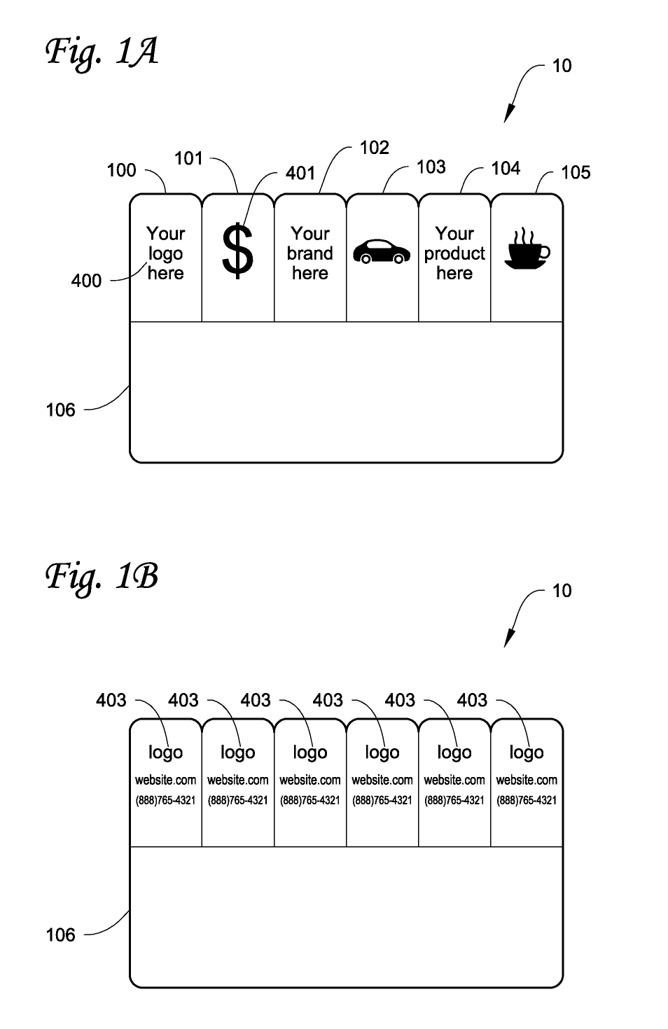

An embodiment of the organization aid device 100 is smaller than a credit card 300. An embodiment of the organization aid device 100 has a width that is less than or equal to the length of a credit card 300. An embodiment of the organization aid device 100 has a length that is less than or equal to the width of a credit card 300. In an embodiment, shown in FIGS. 1a and 1b, the organization aid device 100 has a width of about 1/6 of the length of the credit card 300. In the embodiment, shown in FIGS. 1a and 1b, the organization aid device 100 has a length that is about ½ the width of the credit card 300.

An embodiment of the organization aid device 100 is smaller than a card-like device that is being organized. In an embodiment, the organization aid device 100 has a width that is about ⅙ of the length of a card-like device. In the embodiment, the organization aid device 100 has a length that is about ½ the width of a card-like device.

An embodiment of the organization aid device 100 includes a tab. In an embodiment, the tab has a width that is less than or equal to the width of the organization aid device 100. In an embodiment, the tab has a width that varies, for example by having rounded corners.

In an embodiment, shown in FIGS. 1a and 1b, the organization aid device 100 has a tab having a width of about ⅙ of the length of a credit card 300. In the embodiment, shown in FIGS. 1a and 1b, the organization aid device 100 has a tab having a length that is less than ½ the width of a credit card 300.

An embodiment of the organization aid device 100 includes an indicator 400. In an embodiment, the indicator 400 is on the tab. In an embodiment, the indicator 400 is on a major surface of the tab. In an embodiment, the tab includes one or more indicators. In an embodiment, the tab has an indicator 400 on one or more major surfaces. In an embodiment, the tab has an indicator 400 on one or more minor surfaces. In an embodiment, the tab has an indicator 400 on every surface. In an embodiment, the tab has an indicator 400 inside a material making up the tab. In an embodiment, the indicator 400 is removable from the tab. In an embodiment, the indicator 400 is attachable to the tab. In an embodiment, the indicator 400 is in the tab.

The indicator 400 may be visual or tactile or both. A visual indicator 400 includes letters, numbers, logos, icons, signs, barcode, any marking, or combinations thereof. A tactile indicator 401 includes textures to permit identification of a specific tag by the feel of the tab. Texturing can be provided by protrusions, indentations, alternate layers of material, additions of objects adhered to the tab, or combinations thereof, which allows an appropriate tactile feel. Tactile indicators allow identification in dark environments. For individuals who have impaired sight, the tactile indicator may include Brail encodings which would allow for identification and the user's selection of desired card.

Indicators may be used to provide advertisements and/or commercial advantages. For example, in certain commercial settings where it is desirable to provide coupons, discounts, or loyalty program content, the tab may include an indicator which may be encoded with a conventional barcode, such as a PDF417 or code 148, or similar indicator, which enables commercially available barcode scanners to read the coupon content or loyalty content thereby enabling a single card/loyalty enablement. For example, a grocery store that provides reward cards can provide a reward tab which when scanned as part of the checkout process provides rewards to the consumer. The consumer needs have only the card/tab combination to initiate both rewards and payments. An embodiment of the organization aid device 100 includes one or more of the indicators stated above.

An embodiment includes a card-like device connected to the organization aid device 100. In an embodiment, the organization aid device 100 includes a tab portion 202 and a surface including an adhesive for adhering the surface to the card-like device. In an embodiment, an adhesive permits either permanent or temporary adhesion to the credit card 300. In an embodiment, the organization aid device 100 includes an adhesive which permits a permanent adhesion to the credit card 300. In an embodiment, the organization aid device 100 includes an adhesive which permits a temporary adhesion to the credit card 300. In an embodiment, the organization aid device 100 has a surface including an indicator 400 and an adhesive thereon. In an embodiment, the organization aid device 100 has a first surface including an indicator 400 and a second surface including an adhesive thereon. In an embodiment, the organization aid device 100 has a first surface including an indicator 400 and a second surface including a second indicator 403 and an adhesive thereon.

An embodiment of the organization aid device 100 is made of a thin sheet of polycarbonate material. An embodiment of the organization aid device 100 includes a tab which is made of a thin sheet of polycarbonate material. An embodiment of the organization aid device 100 is made of a thin sheet of polycarbonate material on which is imprinted an indicator 400. An embodiment of the organization aid device 100 includes a tab which is made of a thin sheet of polycarbonate material on which is imprinted an indicator 400. An embodiment of the organization aid device 100 is made of a thin sheet of polycarbonate material on which is imprinted a logo corresponding to a brand of a credit card 300. An embodiment of the organization aid device 100 includes a tab which is made of a thin sheet of polycarbonate material on which is imprinted a logo corresponding to a brand of a credit card 300.

An embodiment of an organization aid device 100 consists of a thin sheet, an indicator 400 disposed on a surface of the thin sheet, and an adhesive on at least a portion of the thin sheet. An embodiment of an organization aid device 100 consists of a thin sheet, an RFID chip in the thin sheet, and an adhesive on at least a portion of the thin sheet. An embodiment of an organization aid device 100 consists of a thin sheet, an RFID chip in the thin sheet, an indicator 400 disposed on a surface of the thin sheet, and an adhesive on at least a portion of the thin sheet. As shown in FIGS. 1 a and lb, an embodiment of the organization aid carrier device 10 includes one or more organization aid devices 100, 101, 102, 103, 104, 105 and a carrier portion 106.

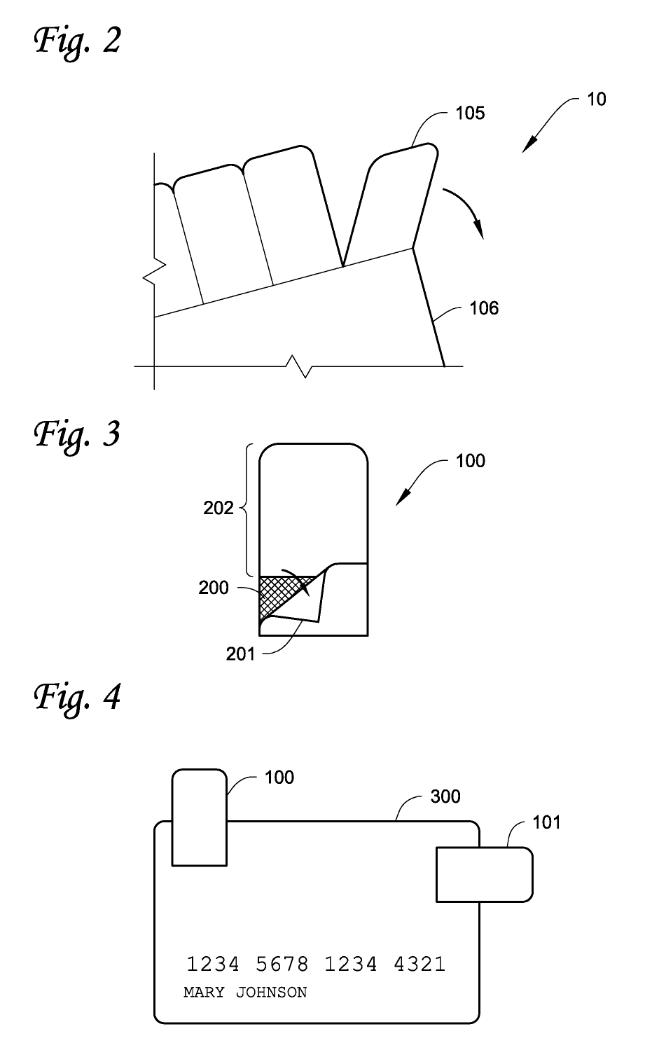

An embodiment of the organization aid carrier device 10 comprises a plurality of organization aid devices 100, 101, 102, 103, 104, 105 configured to be detachable from a carrier portion 106. In an embodiment, each of the organization aid devices 100, 101, 102, 103, 104, 105 of the organization aid carrier device 10 includes a first surface having an indicia, and a second surface that includes an adhesive layer 200 between the second surface and a removable layer 201. In an embodiment, the organization aid devices 100, 101, 102, 103, 104, 105 are fabricated as a single piece with perforations between the organization aid devices 100, 101, 102, 103, 104, 105 which permit individual organization aid devices 100, 101, 102, 103, 104, 105 to be separated from the carrier portion 106, as shown in FIG. 2.

One embodiment of the organization aid carrier device 10 is made of a single material, having two major surfaces, wherein on a portion of one of the major surfaces is a layer of adhesive, a protective removable layer on top of the adhesive layer configured to be removable by a user, wherein an etched line, perforation, and/or scored line, is provided on one of the major surfaces such that one of the organization aid devices 100, 101, 102, 103, 104, 105 may be separated from the carrier portion 106 of the organization aid carrier device 10.

An embodiment of the organization aid carrier device 10 is sized to be a card-like device. Accordingly, the embodiment of the organization aid carrier device 10 follows one of the international standards that defines the physical characteristics, such as for example, ISO/IEC 7810, ISO/IEC 7813, ISO/IEC 7811, and/or ISO/IEC 7816. Accordingly, the embodiment of the organization aid carrier device 10 may have dimensions according to ID-1, ID-2, ID-3, or ID-000. One embodiment of the organization aid carrier device 10 has dimensions of 85.60 mm×53.98 mm. One embodiment of the organization aid carrier device 10 has dimensions of 105 mm×74 nun One embodiment of the organization aid carrier device 10 has dimensions of 125 mm×88 mm. One embodiment of the organization aid carrier device 10 has dimensions of 25 mm×15 mm.

One embodiment of the organization aid carrier device 10 follows ISO/IEC 7813 and has dimensions of 85.60 mm×53.98 mm, a thickness of 0.76 mm, and corners rounded with a radius of 3.18 mm.

In an embodiment, the carrier portion 106 includes an advertising display. In an embodiment, the organization aid carrier device 10 includes six organization aid devices 100, 101, 102, 103, 104, 105, each configured to be detachable. In an embodiment, the organization aid carrier device 10 is substantially the same size as the credit card 300. In an embodiment, the organization aid carrier device 10 is substantially the same size as the card-like device. In an embodiment, the organization aid carrier device 10 includes an extension of material outside of the organization aid device 100 for retail display. In an embodiment, the organization aid carrier device 10 includes a “j hook” connected to the carrier portion 106 for retail display. The carrier portion 106 may include instructions on the method of using the carrier aid device.

An embodiment of a system for organizing card-like devices includes a stack of card-like devices in a single pouch, such as for example, but not limited to, in a wallet. The embodiment of the system includes one or more cards having an attached tab. In an embodiment of the system including at least two cards each having an attached tab, the tabs are in staggered position relative to each other for easy identification, permitting grasping of one tab isolated from the other tab(s) and separating the desired card attached to the grasped tab from the stack. The staggered tabs may overlap. The staggered tabs may not overlap.

An embodiment of a system for organizing card-like devices includes a stack of card-like devices, wherein each of the card-like devices includes an organization aid device 100 attached to a surface of the card-like device, wherein the organization aid device 100 includes a tab portion 202 that extends away from an edge of the card-like device.

Use of the organization aid devices 100, 101, 102, 103, 104, 105 as a system can be for single cards or groups of cards. In group usage, the organization aid devices 100, 101, 102, 103, 104, 105 can be offset by a distance, for example, a distance equal to the width of the tab, thus permitting visual and/or tactile identification of, for example, which credit card 300 or card-like device is attached to the particular tab or a portion of the organization aid device 100 that can be identified. The orientation of the organization aid device 100 attached to the card-like device 300 can be either perpendicular to the long side or the short side of the card 300. In other words, the orientation of the attachment of the organization aid device 100, 101 to the card-like device 300 can be near an edge of the length side or the width side, as shown in FIG. 4, which shows examples of both attachment orientations on one card-like device 300. User selection of orientation permits a variety of wallet structures from which card-like devices can be accessed, stored, and/or removed based on the desire and convenience of the user.

The organization aid devices 100, 101, 102, 103, 104, 105 may be removable as necessitated by the use with an ATM type device that is configured to ingest the entire card-like device for reading. Alternatively, tabs can be fabricated by an extremely flexible albeit strong material, such as 1 mil Mylar, or 2 mil Mylar, and/or other thin shaped flexible material, which can readily survive the ingestion without damage or jamming the reader mechanism.

The fabrication technologies of the organization aid device 100 and/or the organization aid carrier device 10 can be performed by multi-laminate printing technologies on a variety of material stocks. In a preferred embodiment, the organization aid device 100 and/or the organization aid carrier device 10 is produced as sections of a single conventional 18×24 printer sheet through a multi-pass lamination process in which various layers, substrate, adhesive, overprint layers (top & bottom) are laminated onto the sheet producing a multiple of card templates. A final press run through a die cutter separates the cards from the sheets and also segments the tabs for mechanical removal by the consumer. The process is a printing process which can be performed by conventional printing means, thereby dramatically reducing the costs of production.

In an embodiment, the organization aid device 100 and/or the organization aid carrier device 10 can be fabricated in a manner which includes the incorporation of a smart chip, an RFID tag, and/or an RFID chip. Incorporating the smart chip, the RFID tag, and/or the RFID chip into the organization aid device 100 makes the organization aid device 100 a “smart tab.” The smart tab can be used to enhance the information content of the card-like device and give the card-like device the functional equivalence of a smart card at a fraction of the cost of a typical smart card. Additionally, this avoids the mechanical design aspects of a smart card which limit the life expectance due to flex breakage. In an embodiment, the card-like device retains functionality of the original card-like device and only the organization aid device 100 need to be replaced with a new and/or different embedded electronics module or chip. Further, tiered capabilities for a given card can be granted by a selection of appropriate “smart tabs”. For example, tier one may be a smart chip organization aid device 100 with a few kilobytes of data storage whereas an advance tier may contain a smart chip organization aid device 100 with a few megabytes of data storage. Other variations to those described herein are also envisioned.

Adhesives used on the organization aid device 100 can be either strong or removable. By choosing from a variety of tack properties for pressure sensitive adhesives, for example any of the pressure sensitive styrene block copolymer family commercially available from many companies such as 3M, the degree of adhesion between the tab and card can be permanent, or removable, or reusable, depending on the intended use of the card.

A preferred embodiment has been described for illustrative purposes. Those skilled in the art will appreciate that various modifications and substitutions are possible without departing from the scope of the invention, including the full scope of equivalents thereof.

What is claimed is:

1. An organization aid device for a card-like device, comprising:
a tab portion, and
a flat surface including an adhesive for adhering the flat surface to the card-like device.

2. The organization aid device according to claim 1, further comprising an indicator disposed on the tab portion for identification of the organization aid device.

3. The organization aid device according to claim 1, further comprising an indicator disposed on the tab portion for identification of the card-like device.

4. The organization aid device according to claim 3, wherein the indicator includes a visual indicator.

5. The organization aid device according to claim 3, wherein the indicator includes a tactile indicator.

6. The organization aid device according to claim 5, wherein the tactile indicator that is in Braille for reading by touch.

7. The organization aid device according to claim 1, wherein the adhesive is a permanent adhesive, wherein the card-like device can permanently attached to the flat surface.

8. The organization aid device according to claim 1, wherein the adhesive is a temporary adhesive, wherein the card-like device can removably attached to the flat surface.

9. The organization aid device according to claim 1, further comprising an electronic component that stores data, the electronic component configured to provide data to a sensor device for communicating the data to the sensor device and to a computer connected to the sensor device.

10. The organization aid device according to claim 1, wherein the tab portion includes a bar code that encodes information linked to a coupon, loyalty program, discount, or other data.

11. The organization aid device according to claim 1, wherein the organization aid device includes a 2 mil Mylar material which permits non-jamming insertion and removal from automatic credit card reading devices.

12. An organization aid carrier device, comprising:
a plurality of the organization aid devices according to claims 1,
wherein the organization aid carrier device is a card-like device.

13. The organization aid carrier device according to claim 12,
further comprising a carrier portion connected to six organization aid devices,
wherein each of the organization aid devices are configured to be detachably removable from each other and from the carrier portion,

14. The organization aid carrier device according to claim 13, wherein each of the organization aid devices have a width that is ⅙ the length of the carrier portion,

15. The organization aid carrier device according to claim 14, wherein each of the organization aid devices have a length that is ½ the width of the organization aid carrier device.

16. A method of using an organization aid carrier device, comprising:
detaching the organization aid device from an organization aid carrier device;
removing a removable layer from the organization aid device to expose an adhesive layer on a surface of the organization aid device; and
attaching a card-like device to the adhesive layer to attach the card-like device to the organization aid device, such that a tap portion of the organization aid device extends outward from an edge of the card-like device.

17. An organization system for credit cards contained within a wallet, comprising:
an organization aid device attached to one of the credit cards, a tab portion of the organization aid device is smaller than the credit card, wherein the tab portion extends beyond an edge of the credit card, the tab portion including an indicator that uniquely identifies the credit card apart from other credit cards.

18. The system according to claim 17, wherein the organization aid device includes an adhesive surface that adheres to the credit card.

19. The system according to claim 18, wherein the adhesive surface includes a permanent adhesive.

20. The system according to claim 18, wherein the adhesive surface includes a temporary adhesive.

21. The system according to claim 17, wherein the indicator is a visual indicator including a logo, a color, for uniquely identifying an intended purpose of the credit card attached to the organization aid device.

22. The system according to claim 17, wherein the indicator is a tactile indicator including a raised bump for uniquely identifying an intended purpose of the credit card attached to the organization aid device.

23. The system according to claim 17, wherein the indicator includes a visual indicator and a tactile indicator.

24. An organization system for card-like devices contained within a card carrier, comprising:
a plurality of tabs, each tab attached to one of the card-like devices,
wherein the tab is smaller than the card-like device that is attached to, and a portion of the tab extends beyond an edge of the card-like device, each tab includes an indicator that uniquely identifies the card-like device that is attached to apart from other card-like devices.

25. The system according to claim 24, wherein the card-like devices are in a stack and the plurality of tabs are positioned staggered along a length of the edges of the card-like devices.

26. The system according to claim 24, wherein the plurality of tabs are different physical sizes from each other.

27. The system according to claim 24, wherein each tab includes a RFID or other passive or electronic elements which provide indications to non-human sensory devices and convey information unique to the tab.

28. An organization aid carrier device, comprising:
a body formed of a single material having two major surfaces, a length, and a width, wherein the length is longer than the width, wherein the body has dimensions of a card-like device;
a perforation provided on one of the major surfaces, the perforation defining a carrier portion of the body and an organization aid device portion of the body, the perforation being a breaking portion of the body such that the organization aid device portion is separable from the carrier portion;
an adhesive layer disposed on a portion of one of the major surfaces of the organization aid device portion of the body; and
a protective removable layer disposed on top of the adhesive layer, wherein the protective removable layer is configured to be removable by a user.
